(19) United States
(12) Patent Application Publication
(10) Pub. No.: US 2011/0143096 A1
(43) Pub. Date: Jun. 16, 2011

(54) THIN FILM, CASING WITH DECORATIVE PATTERN, THIN FILM MANUFACTURING METHOD AND CASING MANUFACTURING METHOD

(76) Inventor: HONG-YI HUANG, Taoyuan (TW)

(21) Appl. No.: 12/785,482

(22) Filed: May 23, 2010

(30) Foreign Application Priority Data
Dec. 14, 2009 (TW) 098142825

(51) Int. Cl. B32B 3/30; B41M 3/12; B44C 1/17

(52) U.S. Cl. 428/161; 427/147; 156/239

(57) ABSTRACT

A thin film, a casing with decorative pattern, a thin film manufacturing method, and a casing manufacturing method are disclosed. The thin film includes a carrier film, a structure layer formed on the carrier film, a hardened layer, a release layer between the hardened layer and the carrier film, and an adhesive layer. The structure layer has a first pattern. The hardened player includes a recess portion forming a second pattern the same as the first pattern. The thin film manufacturing method comprises preparing the carrier film, forming in order the structure layer on the carrier film, the release layer on the structure layer, and the hardened layer on the release layer, and forming the adhesive layer above the hardened layer. By the casing manufacturing method, the hardened layer of the thin film adheres to a casing through the adhesive layer so as to obtain the casing with decorative pattern.

### BACKGROUND OF THE INVENTION

1. Field of the Invention

The present invention relates generally to a thin film, a casing with decorative pattern, a thin film manufacturing method and a casing manufacturing method, and more particularly, to the thin film with three-dimensional pattern, the casing with decorative pattern, the thin film manufacturing method and a casing manufacturing method.

2. Description of the Prior Art

In-mold Decoration (IMD) has become one of the major techniques for the surface decoration and has applications mainly in the surface decoration and function panel of home appliance, such as the window lens and casing of the sell phone, the control panel of the washing machine, the refrigerator, the air conditioner and electrical pot, the dashboard and panel in many other fields. In-mold decoration belongs to one of the techniques of transfer printing and generally comprises In-Mold Label (IML), In-Mold Roller (IMR) and In-Mold Film (IMF).

The process of in-mold decoration is carried out by first printing the ink on the carrier in advance and then putting the carrier with the printed ink into the mold. When the injection molding is performed, the ink (the formed pattern) will be directly transformed onto the injection molding part to complete the decoration. However, the common ink printing techniques remain in the category of planographic printing. Even with the utilization of multi-step printing to bring the three-dimensional visualization effect by the stack of the ink, the effectiveness is still limited. Therefore, the emphasis of the pattern is still carried out mostly by the color contrast on the while.

### SUMMARY OF THE INVENTION

The objective of the present invention is to provide a thin film, a casing with decorative pattern, a thin film manufacturing method of and a casing manufacturing method. By forming the recessed structure on the hardened layer, which has protective effect, apparent three-dimensional visualization effect is provided to overcome the insufficiency of the three-dimensional visualization effect encountered in the prior art.

According to the present invention, the thin film comprises a carrier film, a structure layer, a hardened layer, a release layer and an adhesive layer. The structure layer is formed on the carrier film and including a first pattern. The hardened layer includes a first side and a second side. The first side includes a recess portion, which forms a second pattern the same as the first pattern. The release layer is formed between the hardened layer and the structure layer. The adhesive layer is disposed on the second side of the hardened layer.

Furthermore, the structure layer includes a plurality of beads, which forms a plurality of small cavities on the surface of the recess portion. The beads have a diameter in the range between 0.5 micron and 200 microns. Although the three-dimensional structure formed by the hardened layer already has three-dimensional visualization effect, a decorative layer (such as the printing ink) may be further formed between the hardened layer and the adhesive layer in the present invention to enhance the visualization effect on the whole.

According to the present invention, the casing with decorative pattern comprises a body and a thin film. The body includes a surface where the thin film is adhered on. The thin film includes a hardened layer and an adhesive layer. The hardened layer includes a first side and a second side. The first side includes a recess portion, which forms a decorative pattern. The adhesive layer is disposed on the second side to fix the hardened layer onto the body. In practical application, the decorative pattern is the second pattern mentioned hereinabove, while the thin film of the casing here is the thin film mentioned hereinabove after the carrier film, the structure layer and the release layer are peeled off. Similarly, the beads of the structure layer forms a plurality of small cavities on the surface of the recess portion to enhance the visualization effect on the whole.

According to the present invention, the thin film manufacturing method comprises the following steps of: preparing a carrier film; forming a structure layer on the carrier film, wherein the structure layer includes a first pattern; forming a release layer on the structure layer; forming a hardened layer above the release layer, wherein the hardened layer includes a first side and a second side, and the first side includes a recess portion, which forms a second pattern generally the same as the first pattern; and forming an adhesive layer on the second side. At this point, the thin film of the present invention is formed.

The structure layer further includes a plurality of beads and can be formed on the carrier film by screen printing, flexo printing or relief-block printing. After the hardened layer is formed on the release, the beads of the structure layer will form a plurality of small cavities on the surface of the recess.

According to the present invention, the casing manufacturing method comprises the following steps of: preparing a thin film, that is, the thin film mentioned hereinabove which comprises the carrier film, the structure film, the hardened layer, the release layer and the adhesive layer; preparing a body; and adhering the thin film to the body.

According to the present invention, the casing manufacturing method further comprises the following steps of: heating the adhesive layer to adhere the thin film to the body; and detaching the structure layer and the release layer from the hardened layer by drawing the carrier film with a suction device or by holding the carrier film with other mechanism.

Therefore, the hardened layer provided by the present invention not only has the protection function but also has the three-dimensional structure to provide three-dimensional visualization effect. The hardened layer is further formed with a plurality of small cavity by the small beads in the three-dimensional structure to effectively overcome the insufficiency of the three-dimensional visualization effect encountered in the prior art.

The advantage and spirit of the invention may be understood by the following recitations together with the appended drawings.

### BRIEF DESCRIPTION OF THE APPENDED DRAWINGS

FIG. 1 is a cross-sectional view of the thin film according to one embodiment of the present invention.

FIG. 2 is a schematic view of the first pattern formed by the structure layer.

FIG. 3 illustrates the detachment of the carrier film, the structure layer and the release layer

FIG. 4 is a partial cross-sectional view of the casing with decorative pattern according to one embodiment of the present invention.

FIG. 5 is a flow chart of the thin film manufacturing method according to one embodiment of the present invention.

FIG. 6 is a flow chart of the casing manufacturing method according to one embodiment of the present invention.

FIG. 7 illustrates the injection-molding of the thin film with the body.

### DETAILED DESCRIPTION OF THE INVENTION

Please refer to FIG. 1, which is a cross-sectional view of the thin film 1 according to one embodiment of the present invention. The thin film 1 comprises the carrier film 12, the structure layer 14, the hardened layer 16, the release layer 18, the adhesive layer 20, the decorative layer 22 and the antistatic layer 24. The carrier film 12 is used to sustain the multi-layer structure. The material of the carrier film 12 can be selected from Polyester (PET), Polycarbonate (PC), Casted Polypropylene (CPP), or other material that can be made into the film to sustain the multi-layer structure. The thin film 1 has a thickness in the range between 25 microns and 200 microns. Preferably, the thin film 1 has a thickness of about 20 microns. However, the present invention is not limited thereto.

The structure layer 14 is formed on the carrier film 12 and has a first pattern. The material of the structure layer 14 mainly comprises resin 142 and a plurality of beads 144, which is mixed into the resin 142. The material of the resin 142 can be selected from the thermosetting resin, ultraviolet curable resin or electron beam curable resin. The material of the beads 144 can be selected from the organic or inorganic powder which has a diameter in the range between 0.5 micron and 200 microns, Particularly, the preferred diameter of the beads 144 is about 1 micron. The shape of the beads 144 is not limited to the sphere and can be polyhedron, rod or flake.

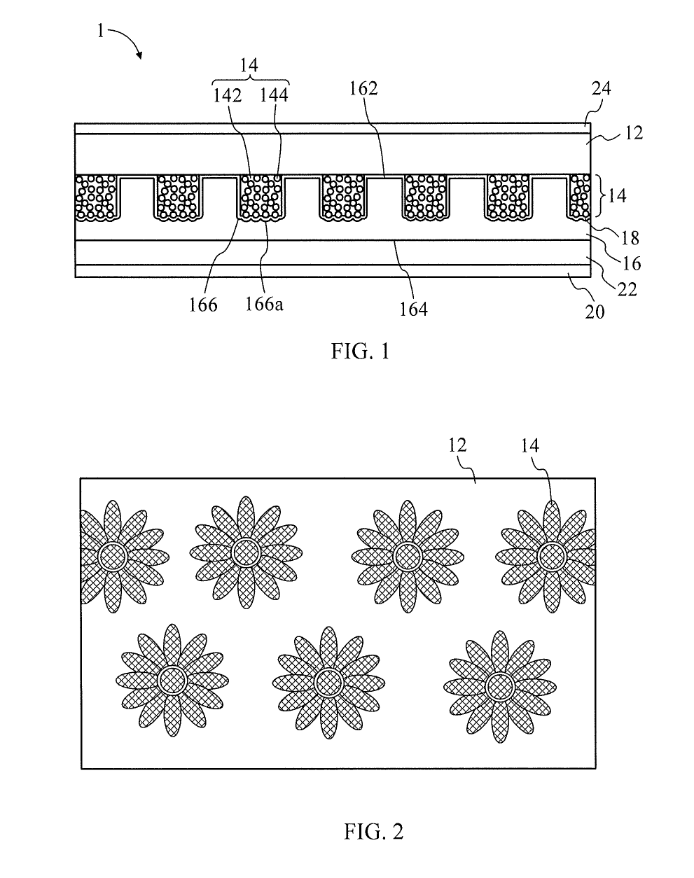

After the structure layer 14 is formed on the carrier film 12, the thickness of the structure layer 14 can be in the range between 1 micron and 50 microns. The beads 144 will form a plurality of protruding bumps on the surface of the structure layer 14. The first pattern can be consulted in FIG. 2. FIG. 2 is a schematic view of the first pattern formed by the structure layer 14 and is the top view perspective of the thin film 1 in FIG. 1. As illustrated in FIG. 2, the first pattern has flower shapes, of which the hatching area is the rough surface caused by the protrusion of the beads 144. Therefore, the structure layer 14 is not limited to a continuous entity. The first pattern formed by the structure layer 14 in FIG. 1 is a plurality of discrete flows, of which the petals and the center part are separated too; however, the present invention is not limited thereto. In short, the first pattern formed by the structure layer 14 can be formed according to the design in practical application. The density of the mixed beads 144 in the resin 142 of the structure layer 14 is not necessary be homogeneous. Furthermore, the structure layer 14 can have different surface roughness by printing with the resin 142, which is mixed with the beads 144 of different density.

The release layer 18 is formed on the structure layer 14. The material of the release layer 18 can be selected from silicone, melamine, fluoro resin or other material which can be used to detach the layer structure. The release layer 18 has a thickness in a range between 0.05 micron and 0.75 micron. In the present embodiment, because the structure layer 14 is formed on the carrier film 12 by printing, part of area of the carrier film 12 is not covered with structure layer 14 and therefore part of the release layer 18 is formed on the carrier film 12. Similarly, if the structure layer 14 covers all the area on the carrier film 12, then the release layer 18 is merely formed on the structure layer 14. Basically, the release layer 18 is used to detach the carrier film 12 and the structure layer 14 from the hardened layer 16 after the transfer printing and therefore only need to exist between the hardened layer 16 and the carrier film 12 and between the hardened layer 16 and the structure layer 14. Accordingly, the coating of the release layer 18 is operated on the principle that no direct contact can be formed by the follow-up hardened layer 16 with the structure layer 14 and the carrier film 12. Of course, if the carrier film 12 and the hardened layer 16 are difficult to adhere to each other in nature, then the contact part between the hardened layer 16 and the carrier film 12 may not need the release layer 18 therebetween.

The hardened layer 16 is formed on the release layer 18. The material of the hardened layer 16 can be UV-curable or electron beam curable acrylic-modified polyester resin. The thickness of the hardened layer 16 is a range between 5 microns and 10 microns. The hardened layer 16 includes a first side 162 and a second side 164. Because the hardened layer 16 contacts the carrier film 12 and the structure layer 14 by the first side 162 (with the release layer 18 existing between the interfaces thereof), the hardened layer 16 is formed with the recess portion 166 on the first side 162 corresponding to the three-dimensional structure (which is used to form the first pattern) of the structure layer 14.

The recess potion 166 form into the second pattern the same as the first pattern and have a corresponding structure according to the recess and protrusion. Therefore, FIG. 2 can also be referred for the second pattern. More specifically, the relative position of the recessed portion with respect to the first pattern would be the relative position of the protrusion portion with respect to the second pattern. On the contrary, the relative position of the protrusion portion with respect to the first pattern would be the relative position of the recessed portion with respect to the second pattern.

Furthermore, because the beads 144 cause the structure layer 14 to have a profile of uneven surface, the surface of the recess portion 166 is also formed with a plurality of small cavity 166a, which has effect of matt surface that can enhance the three-dimensional visualization effect of the second pattern. In addition, because the thickness of the hardened layer 16 in the present embodiment is not thick, the second side 164 of the hardened layer 16 is not as flat as that indicated in FIG. 1 actually, but ripples according to the profile of the structure layer 14. That is, presenting the second side 164 by the flat surface is merely for the convenience of the illustration. Of course, if the thickness of the hardened layer 16 is thick enough, the ripple situation described hereinabove can be greatly reduced. What is supplemented here is that because the thin film 1 is used for the decoration of the appearance of other objects while the decorated surface may not be flat, the hardened layer 16 must have certain stretch rate to overcome the cracking that may cause by the unevenness surface of the object. In the present embodiment, the hardened layer 16 has a stretch rate in a range between 100% and 180% so that the thin film 1 is adapted to decorate most of the smooth surface.

Although the hardened layer 16 has the three-dimensional structure caused by the structure of the structure layer 14 to provide the three-dimensional visualization effect, the effect of the decoration may be further enhanced with the adjustment of color expression. Therefore, in the present embodiment, the decorative layer 22 is formed on the second side 164 of the hardened layer 16 before the formation of the adhesive layer 20. The decorative layer 22 can be formed by printing with monochromatic or color ink. If the dark ink can be applied to the recess portion 166 corresponding to the first side 162, the three-dimensional visualization effect can be further enhanced.

After the decorative layer 22 is formed, the adhesive layer 20 can be formed on the decorative layer 22 and the area of the second side 164 of the hardened layer 16 which is not printed with ink. That is, the decorative layer 22 is formed between the hardened layer 16 and the adhesive layer 20. The material of the adhesive layer 20 is chosen according to the environment of the thin film 1. For example, the temperature for the adhesion function to take effect can be set above the molding temperature when injection molding is performed. Basically, the adhesive layer 20 should not have adhesion characteristic under room temperature to prevent the adhesion onto other objects. Of course, if an isolation layer can be formed on the carrier film 12 opposite the structure layer 14, then it can prevent the thin film 1 to adhere to itself. However, whether the isolation film is formed or not, the antistatic layer 24 can be formed on the carrier film 12 opposite the structure layer 14, as shown in FIG. 1. The antistatic layer 24 can be formed by additional coating or by directly treating the carrier film. Generally, the material of the adhesive layer 20 is selected form the material which has no adhesion characteristic under room temperature, such as modified acrylic resin, to prevent the problem described hereinabove.

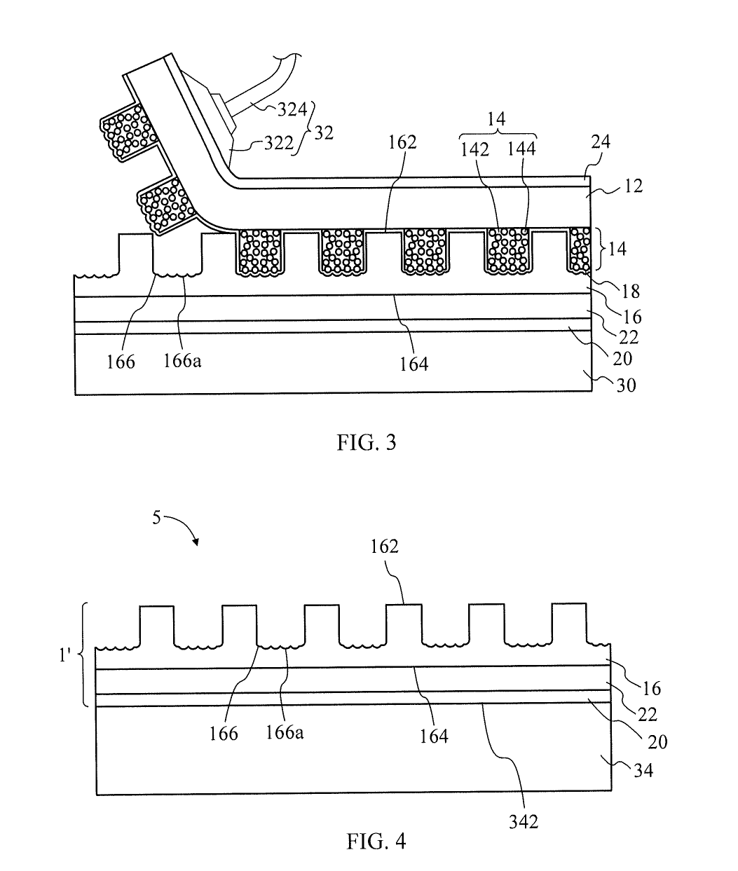

What is supplemented here is that, when using the thin film 1 described hereinabove, if the thin film 1 has already adhered to the surface of the object 30 by the adhesive layer 20, then the suction device 32 can be utilized to suck and draw the carrier film 12 so as to detach the carrier film 12, the structure layer 14 and the release layer 18 from the hardened layer 16. As shown in FIG. 3, the detachment of the carrier film 12, the structure layer 14 and the release layer 18 is illustrated therein. The suction device 32 includes a suction cup 322 and a suction pipe 324 connected to the suction cup 322. The suction device 32 utilizes the suction pipe 324 to exhaust the suction cup 322 so as to suck and hold the carrier film 12 (with the antistatic layer 24). By drawing away the suction cup 322, the release layer 18, the structure layer 14, the carrier film 12 and the antistatic layer 24 will together detach from the hardened layer 16 to complete the detachment. It should be mentioned that the introduction of the suction device 32 is merely for the automation of detachment and the present invention is not limited thereto. The operator may use other similar device or tool to suck or draw the carrier film 12 (with the antistatic layer 24) to achieve the same effect brought by the suction device 32 mentioned hereinabove.

What should be further supplemented is that the size of the each layers of the thin film 1 shown in FIGS. 1 and 3 are not illustrated in the actual size. The size of the layers depicted in the figure is for the purpose of illustrating the structure and relationship between the layers. For the following figures, the presented expression would be of the same purpose and configuration.

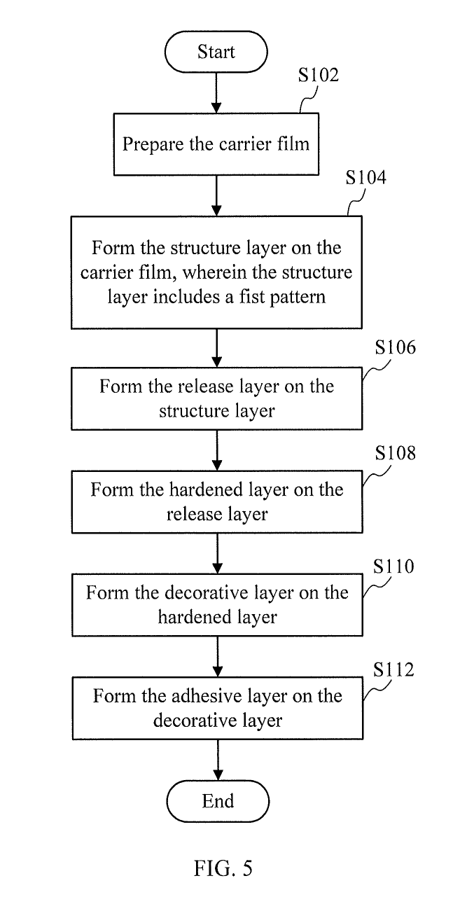

Please refer to FIG. 4, which is the partial cross-sectional view of the casing 5 with decorative pattern of one embodiment of the present invention. The casing 5 includes the body 34 and the thin film 1′ adhered on the surface 342 of the body 34. The thin film 1′ is the remain of thin film 1 described hereinabove after the carrier film 12 (and antistatic layer 24), the structure layer 14 and the release layer 18 are detached. Therefore, the thin film 1′ includes the hardened layer 16 and the adhesive layer 20. The recess portion 166 at the first side 162 of the hardened layer 16 forms a decorative pattern. The adhesive layer 20 is disposed on the second side 164 to fix the hardened layer 16 onto the body 34. If the object 30 in the FIG. 3 is replaced with the body 34, then the casing 5 with decorative pattern can be formed after the detachment in FIG. 3 is complete. In such situation, the decorative pattern is the second pattern of the thin film 1. In practical application, the casing 5 can be the casing of the electronic device, such as the notebook computer or cell phone. Furthermore, the casing 5 may also be the casing of other objects, such as the automobiles or home decorations. However, the present invention is not limited thereto.

The detail of the thin film 1′ in the casing 5 with decorative pattern mentioned hereinabove can refer to the description of the thin film 1 mentioned hereinabove and will not be described in further detail. In addition, if the plastic shell produced by the injection molding is adopted for the body 34 of the casing 5, then the plastic shell (i.e., the body 34) and the thin film 1 can be injection-molded together by placing the thin film 1 in the molding equipment in advance and then performing injection molding after closing the mode. With further detachment of the carrier film 12 (and the antistatic layer 24), the structure layer 14 and the release layer 18, the casing 5 with decorative pattern is then obtained. The detaching method can be referred in the description of FIG. 3 described hereinabove and will not be described in further detail.

Referring to FIGS. 1 and 5, FIG. 5 illustrates the flow chart of the thin film manufacturing method according to one embodiment of the present invention. Based on the description of the thin film 1 in the embodiments mentioned hereinabove, the thin film manufacturing method comprises the following steps.

First, perform the step S102 of preparing the carrier film 12. Next, perform the step S104 of forming the structure layer 14 on the carrier film 12, wherein the structure layer 14 includes the first pattern. The structure layer 14 can formed on the carrier film 12 by screen printing, flexo printing or relief-block printing and then be cured by heating, UV radiating or electron beam bombarding; however, the present invention is not limited thereto. Therefore, the present invention forms the first pattern by printing and forms the rough surface by the beads 144. For the rest detail of the structure layer 14, including the material, thickness and the characteristic of profile, please refer to the description of the structure layer describe hereinabove.

Then, perform the step S106 of forming the release layer 18 on the structure layer 14. The release layer 18 can be formed on the structure layer 14 (and the carrier film 12) by gravure printing, microgravure coating or slot coating, but is not limited thereto. Description for the coating area, the material, the thickness and other detail of the release layer 18 can be sought in the description hereinabove and therefore will not be further described.

In addition, perform the step S108 of forming the hardened layer 16 above the release layer 18. The hardened layer 16 can be formed on the release layer 18 by gravure printing, microgravure coating or slot coating and then be cured by UV radiating or electron beam bombarding; however, the present invention s not limited thereto. Because the release layer 18 is relative thin comparing to the profile of the structure layer 14 (including the rough surface caused by the beads 144), the overall profile will remain generally the same as that of the structure layer 14. Therefore, the follow-up hardened layer 16 will closely attach to the structure layer 14 and to part of the carrier film 12 which is not covered by the structure layer 14 (while the release layer 18 still exists therebetween). That is, the profile of the structure layer 14 is pressed and printed on the hardened layer 16. As a result, the first side 162 of the hardened layer 16 forms the recess portion 166 corresponding to the structure layer 14 while the recess portion 166 is formed with the second pattern the same as the first pattern. Description for the material, the thickness and the profiles of the hardened layer 16 can be sought in the description hereinabove and therefore will not be further described.

Based on the embodiments described hereinabove, the decorative layer 22 can be formed on the hardened layer 16 before the formation of the adhesive layer 20. However, the present invention is not limited thereto, that is, the formation of the decorative layer 22 is optional. Following the previous step, perform the step S110 of forming a decorative layer 22 on the hardened layer 16. The decorative layer 22 can be formed on the hardened layer 16 by gravure printing, microgravure coating or slot coating, but is not limited thereto. It is not necessary for the decorative layer 22 to be coated on the entire surface of the hardened layer 16 but depend on the actual need of the product. Description for the material, the thickness and the profiles of the hardened layer 16 can be sought in the description hereinabove and therefore will not be further described.

Finally, perform the step S112 of forming the adhesive layer 20 on the second side 164 of the hardened layer 16. If the step S110 is be performed, then the adhesive layer 20 will also cover on the decorative layer 22 (i.e., the area printed with the ink). Other description, such as the material, of the adhesive layer 20 can be sought in the description hereinabove and therefore will not be further described. When all of the steps S102˜S112 are been performed, the thin film 1 of the present invention can be obtained as shown in FIG. 1.

It should be mentioned that the antistatic layer 24 of the thin film 1 in FIG. 1 can be either formed on the carrier film 12 opposite the structure layer 14 after the steps S102˜S112 are completed, or formed on the surface of the carrier film 12 before perform the steps S102˜S112. Alternatively, the surface of the carrier film 12 can be performed with antistatic treatment before the steps S102˜S112.

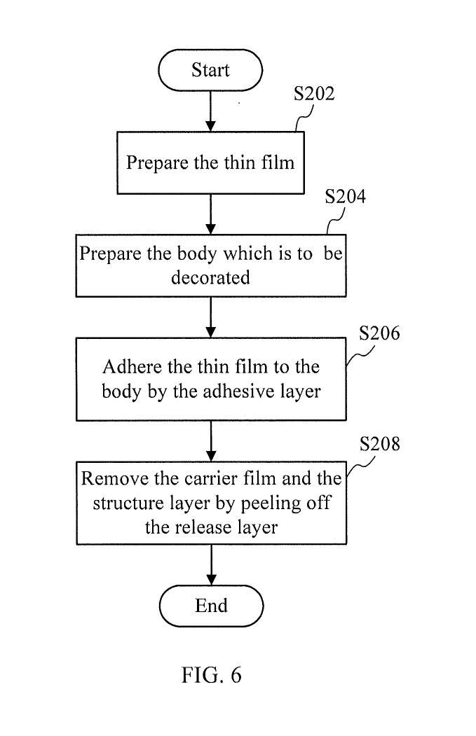

Please refer to FIG. 4 and FIG. 6 together. FIG. 6 illustrates the flow chart of the casing manufacturing method according to one embodiment of the present invention. Based on the description of the casing 5 with decorative pattern and the thin film 1 in the embodiments described hereinabove, the casing manufacturing method comprises the following steps.

First, perform the step S202 of preparing the thin film, that is, the thin film 1 shown in FIG. 1. Here, the thin film 1 can be manufactured by the thin film manufacturing method described hereinabove, that is, the casing manufacturing method comprises the thin film manufacturing method. Next, perform the step S204 of preparing the body that is to be decorated (such as the body 34 or the object 30 described hereinabove). The steps S202 and S204 may be performed at the same time.

Following, perform the step S206 of adhering the thin film 1 to the body 34 by the use of the adhesive layer 20. Different adhesion operations may be performed according to different materials of the adhesive layer 20. Based on the embodiments described hereinabove, the adhesive layer 20 need to be heated to fix the thin film 1 onto the body 34 after the thin film 1 is adhered.

Furthermore, perform the step S208 of removing the carrier film 12 (and the antistatic layer 24), the structure layer 14 and the release layer 18 by peeling off the release layer 18. It should be mentioned that the suction device 32 can be utilized to perform the step of removing, but the present invention is not limited thereto. Finally, the casing adhered with the thin film 1′ (or the thin film 1 with detachment of carrier film 12 and the structure layer 14) is the casing 5 with decorative pattern.

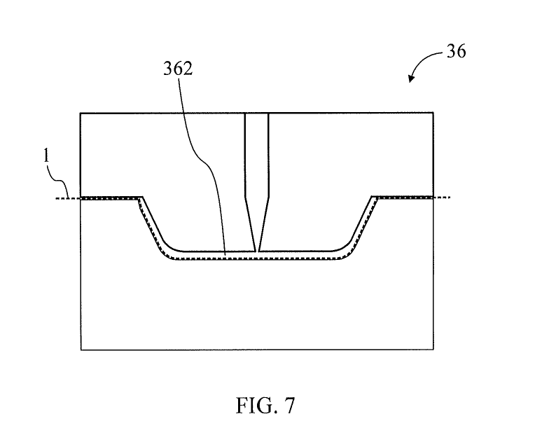

What should be mentioned is that when the casing manufacturing method is carried out, the step S204 of preparing the body 34 and the step S206 of adhering the thin film 1 to the body can be performed together. Please refer to FIG. 7, which illustrates the injection-molding of the thin film 1 with the body 34 together.

The thin film 1 (which is presented by short boldface dashed line in FIG. 7) can be first placed in to the molding equipment 36. While the body 34 (not shown in FIG. 7) is injection-molded by filling the plastic into the mold cavity 362, the thin film 1 will attach closely onto the interior surface of the mold cavity 362. When the mold cavity 362 is full of the plastic, the body 34 will be formed with the thin film 1 attached to the body at the same time. That is, the casing 5 with decorative pattern (before detachment of the carrier film 12 and the structure layer 14) can be one-step formed. At the meantime, if the adhesive layer 20 is made of thermosetting material, then the heat brought by the plastic injected into the mold cavity 362 can heat the adhesive layer 20 directly to complete curing and adhesion.

Based on the description of the embodiments mentioned hereinabove, the hardened layer of the thin film provided by the present invention not only has the protection function, but also has also three-dimensional structure to enhance the three-dimensional visualization effect. The hardened layer forms a plurality of small cavities by utilizing the small beads to further enhance the three-dimensional visualization effect, which can effectively overcome the problem of insufficient three-dimensional visualization effect in the prior art.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A thin film, comprising:
a carrier film;
a structure layer, formed on the carrier film and comprising a first pattern;
a hardened layer, comprising a first side and a second side, the first side comprising a recess portion, and the recess portion forming a second pattern the same as the first pattern;
a release layer, formed between the hardened layer and the structure layer; and
an adhesive layer, disposed on the second side of the hardened layer.

2. The thin film of claim 1, wherein when the adhesive layer adheres to an object, the carrier film can be drawn by a suction device to detach the structure layer and the release layer from the hardened layer.

3. The thin film of claim 1, wherein the structure layer further includes a plurality of beads, and the beads form a plurality of small cavities on a surface of the recess portion.

4. The thin film of claim 3, wherein the beads have a diameter in a range between 0.5 microns and 200 microns.

5. The thin film of claim 1, wherein the structure layer has a thickness in a range between 1 micron and 50 microns.

6. The thin film of claim 1, wherein the carrier film has a thickness in a range between 25 micron and 200 microns.

7. The thin film of claim 1, wherein the hardened layer has a stretch rate in a range between 100% and 180%.

8. The thin film of claim 1, further comprising a decorative layer formed between the hardened layer and the adhesive layer.

9. The thin film of claim 1, further comprising a antistatic layer disposed opposite the structure layer on the carrier film.

10. The thin film of claim 1, wherein a material of the carrier film includes PET, PC or CPP.

11. The thin film of claim 1, wherein a material of the structure layer includes a resin.

12. The thin film of claim 1, wherein a material of the hardened layer includes a resin.

13. The thin film of claim 1, wherein a material of the release layer includes a silicone, a melamine or a fluoro resin.

14. A casing with decorative pattern, comprising:
a body comprising a surface; and
a thin film, adhered on the surface, and the thin film comprising:
a hardened layer, comprising a first side and a second side, the first side comprising a recess portion, the recess portion forming a decorative pattern; and
an adhesive layer, disposed on the second side and adapted to fix the hardened layer on the body.

15. The casing of claim 14, wherein a surface of the recess portion has a plurality of small cavities.

16. The casing of claim 14, wherein the hardened layer has a stretch rate in a range between 100% and 180%.

17. The casing of claim 14, further comprising a decorative layer formed between the hardened layer and the adhesive layer.

18. The casing of claim 14, wherein a material of the hardened layer includes a resin.

19. The casing of claim 14, wherein the casing and the thin film are together injection-molded within a molding equipment.

20. A thin film manufacturing method, comprising the steps of:
preparing a carrier film;
forming a structure layer on the carrier film, wherein the structure layer includes a first pattern;
forming a release layer on the structure layer;
forming a hardened layer above the structure layer, wherein the hardened layer includes a first side and a second side, the first side includes a recess portion, the recess portion forms a second pattern the same as the first pattern; and
forming an adhesive layer on the second side.

21. The thin film manufacturing method of claim 20, wherein the structure layer further includes a plurality of beads, and the beads form a plurality of small cavities on a surface of the recess portion.

22. The thin film manufacturing method of claim 21, wherein the beads have a diameter in a range between 0.5 microns and 200 microns.

23. The thin film manufacturing method of claim 20, wherein a material of the hardened layer includes a resin.

24. The thin film manufacturing method of claim 20, wherein a material of the structure layer includes a resin.

25. The thin film manufacturing method of claim 20, wherein the structure layer is formed on the carrier film by screen printing, flexo printing or relief-block printing.

26. The thin film manufacturing method of claim 20, wherein the hardened layer is formed above the structure layer by gravure printing, microgravure coating or slot coating.

27. The thin film manufacturing method of claim 20, further comprising the step of:
forming a decorative layer on the hardened layer before forming the adhesive layer.

28. A casing manufacturing method, comprising the steps of:
preparing a thin film, wherein the thin film comprises:
a carrier film;
a structure layer, comprising a first pattern;
a hardened layer, comprising a first side and a second side, the first side comprising a recess portion, the recess portion forming a second pattern the same as the first pattern;
a release layer, formed between the hardened layer and the structure layer; and
an adhesive layer, disposed on the second side;
preparing a body; and
adhering the thin film to the body by the adhesive layer.

29. The casing manufacturing method of claim 28, further comprising the step of:
heating the adhesive layer to adhere the thin film on the body.

30. The casing manufacturing method of claim 28, further comprising the step of:
removing the carrier film and the structure layer by peeling off the release layer.

31. The casing manufacturing method of claim 28, wherein the structure layer is formed on the carrier film by screen printing, flexo printing or relief-block printing.

32. The casing manufacturing method of claim 28, wherein a material of the structure layer includes a resin.

33. The casing manufacturing method of claim 28, wherein the structure layer comprises a plurality of beads to form a plurality of small cavities on a surface of the recess portion.

34. The casing manufacturing method of claim 33, wherein the beads have a diameter in a range between 0.5 microns and 200 microns.

35. The casing manufacturing method of claim 28, wherein the structure layer has a thickness in a range between 1 micron and 50 microns.

36. The casing manufacturing method of claim 28, wherein the casing and the thin film are together injection-molded within a molding equipment.

37. The casing manufacturing method of claim 28, further comprising the step of:
detaching the structure layer and the release layer form the hardened layer by drawing the carrier film with a suction device.
